(19) United States
(12) Patent Application Publication
(10) Pub. No.: US 2016/0299913 A1
(43) Pub. Date: Oct. 13, 2016

(54) FILE LOOKUP IN A FILE SYSTEM

(71) Applicants: Kalikivayi SURESH, Bangalore (IN); Jaipal PENDYALA, Bangalore (IN); Tushar VENGURLEKAR, Bangalore (IN); Rajkumar KANNAN, Bangalore (IN); Michael J. SPITZER, Bangalore (IN); HEWLETT PACKARD ENTERPRISE DEVELOPMENT LP, Houston, TX (US)

(72) Inventors: Suresh Kalikivayi, Bangalore Karnataka (IN); Pendyala Jaipal, Bangalore Karnataka (IN); Vengurlekar Tushar, Bangalore Karnataka (IN); Kannan Rajkumar, Bangalore Karnataka (IN); Michael J. Spitzer, Portland, OR (US)

(73) Assignee: Hewlett-Packard Development Company, L.P., Houston, TX (US)

(21) Appl. No.: 15/038,519

(22) PCT Filed: Dec. 6, 2013
(86) PCT No.: PCT/IN2013/000754

§ 371 Date: May 23, 2016

(51) Int. Cl. G06F 17/30

(52) U.S. Cl. CPC G06F 17/30106; G06F 17/30112; G06F 17/30864

(57) ABSTRACT

The present disclosure provides techniques for performing a file lookup. An example of a system includes a file system corresponding to one or more physical storage devices, a database that stores metadata corresponding to files in the file system, and a search module. The reporting framework receives search criteria for a file lookup, generates a complex query based on the search criteria, sends the query to the database, receives search results corresponding to the query, and generates a search report based on the search results. The search criteria include two or more search tokens and one or more Boolean operators.

### BACKGROUND

Various techniques exist that enable a user to search for files in a file system. A typical file lookup technique involves searching the file system directly, which involves physical traversal of the file system tree. This adds the load on the file systems especially when the file system size is large and has a large number of files. Increasing the load on a large file system may result in low Input/Output (I/O) speeds and large access time of the file systems.

### BRIEF DESCRIPTION OF THE DRAWINGS

Certain examples are described in the following detailed description and in reference to the drawings, in which:

FIG. 1 is a block diagram of a system for performing a file lookup using a database associated with a file system;

FIG. 2 is a block diagram of a system showing a more detailed example of the reporting framework of FIG. 1.

FIG. 3 is a process flow diagram of a method of performing a file lookup.

FIG. 4 is a block diagram showing a tangible, non-transitory, computer-readable medium that stores code configured to perform a file lookup.

### DETAILED DESCRIPTION OF SPECIFIC EMBODIMENTS

The present disclosure relates to techniques that enable file lookup on a file system by querying a database associated with the file system. The lookup of files in the file system can be based on several different search tokens without physical traversal of the file system tree using an integrated database in a file system. The file system stores the metadata and user defined custom metadata associated with a file in a database such as an Express query database. Using this database, the lookup for files on these file systems is done by querying the database instead of directly searching the file systems. In this way, a file lookup can be accomplished using additional attributes like retention time and custom metadata, which may not be possible using the traditional techniques. In some examples, a file lookup can be implemented on multiple file systems at the same time. Furthermore, the load on the file system is completely removed. In some examples, the file system is a scale-out file system or a cloud computing system. In some examples, the database is a pipelined database.

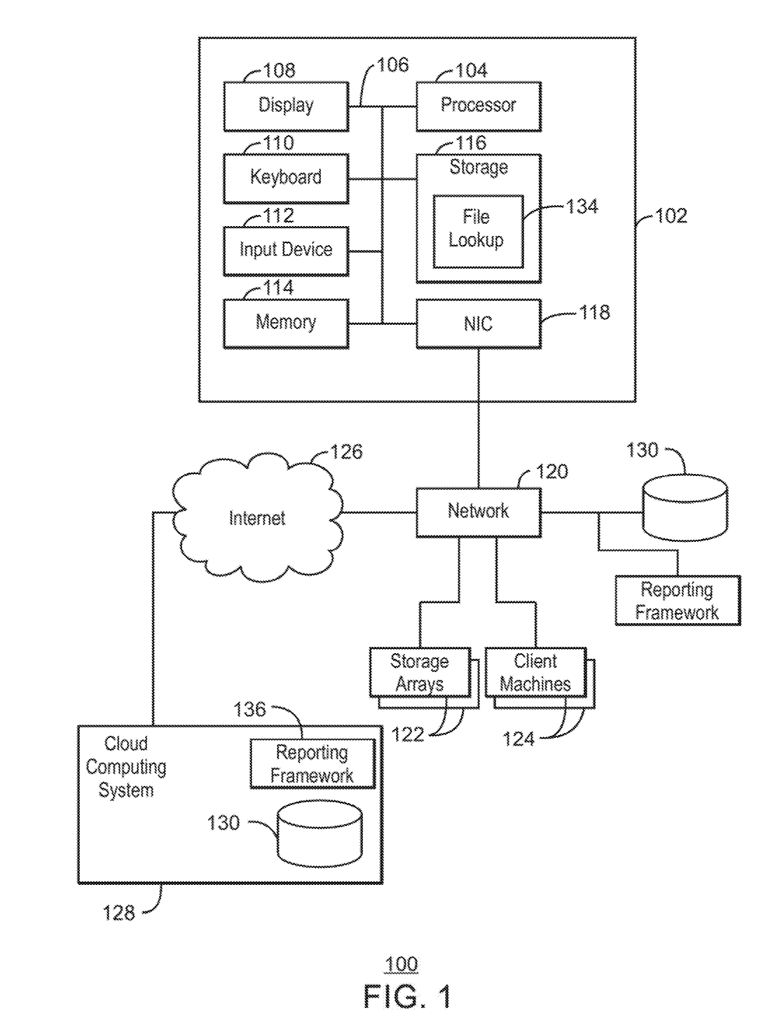

FIG. 1 is a block diagram of a system for performing a file lookup using a database associated with a file system. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are only one example of functional blocks and devices that may be implemented in examples of the present techniques. Those of ordinary skill in the art would readily be able to define specific functional blocks based on design considerations for a particular system.

As illustrated in FIG. 1, the system 100 may include a computing device 102, which will generally include a processor 104 connected through a bus 106 to a display 108, a keyboard 110, and one or more input devices 112, such as a mouse, touch screen, or keyboard. In some examples, the device 102 is a general-purpose computing device, for example, a desktop computer, laptop computer, business server, and the like. The computing device 102 can also have one or more types of tangible, non-transitory, machine-readable media, such as a memory 114 that may be used during the execution of various operating programs, including operating programs used in exemplary embodiments of the present invention. The memory 114 may include read-only memory (ROM), random access memory (RAM), and the like. The device 102 can also include other tangible, non-transitory, machine-readable storage media, such as a storage system 116 for the long-term storage of operating programs and data, including the operating programs and data such as user files.

In some examples, the device 102 includes a network interface controller (NIC) 118, for connecting the device 102 to a network 120. In some examples, the network 120 may be an enterprise network, which is a large private network of an entity such as a business organization. The network 120 may be configured, for example, as a Storage Area Network (SAN), a Serial Attached Storage (SAS), or other network configuration. The network 120 through a local area network (LAN), a wide-area network (WAN), or another network configuration. The network 120 include a variety of coupled devices that are capable of storing files, such as storage arrays 122, and other client machines 124, which may be similar to computing device 102. Through the network 120, the computing device 102 can access other networks, such as the Internet 126. The computing device 102 may be coupled through the Internet 126 to a cloud computing system 128. The cloud system 128 provides a large pool of compute and storage resources that can be dynamically allocated to client computing systems such as the computing device 102. In some embodiments, the cloud computing system 128 and the network 120 can each include several petabytes of storage space.

The computing device 102, the network 120, the client machines 124, and the cloud computing system 128 may each have their own separate file systems. Some or all of these files systems may be associated with a database that stores information related to files in the corresponding file system. For example, a database 130 coupled to the network 120 can include information regarding files stored in the storage arrays 122 of the network 120. Additionally, a separate database 130 associated with the cloud computing system 128 can include information regarding files stored in the cloud computing system 128. Furthermore, although not shown, separate databases can be maintained for the client computer 102, and each of the client machines 124 coupled to the network 120.

Each database 130 can include an entry for each file in the corresponding file system. Each entry can include any number of file attributes, some of which may correspond to metadata tags associated with the file. For examples, file attributes may include file name, file type, location, creation date, modification date, retention time, expiration time, retention state, tier, user ID, Group ID, custom metadata, and other file attributes. The custom metadata can include any number of custom metadata tags, which may be created to satisfy specific needs of the entity generating or using the files. For example, if the file is a medical record such as an X-ray image, the custom tags could include a patient name, identification of the area being imaged, date that the X-ray was performed, doctor name, and the like. A file lookup operation can be performed by generating a query that uses these file attributes as filtering parameters.

The database can be maintained dynamically. For example, each time a change occurs to the file system, such as deleting, updating, or renaming a file, the corresponding database can be updated to reflect the current state of the file system. In some examples, the database 130 is a pipeline database, such as an Express Query database. In some examples, the database can also be a relational database. The database 130 includes file metadata and custom metadata information, which is continuously being added and updated in response to events that are produced by the file system, such as changes to the files. These file system events are converted to database records that are inserted into the database so as to always maintain a correct mapping of the file information in the database so that the file lookup can produce accurate results.

The computing device 102 can access a number of file systems, including the local file system of the computing device 102, the network's 120 file system, the cloud computing system's 128 file system, and the file systems of other client machines 124. The client computing device 102 can include a file lookup utility 134, which may be included in a file browser interface, for example. The file lookup utility 134 enables a user to perform a file lookup on one or more of the file systems within the system 100. The file lookup can be accomplished by querying the corresponding database 130 instead of traversing the file system tree of the specified file system.

To facilitate the file lookup, each database 130 may be coupled to a corresponding reporting framework 136. The system 100 shows a reporting framework 136 coupled to the database 130 of network 120 and a separate reporting framework 136 coupled to the database 130 of the cloud computing system 128. Any additional file systems in the system 100 may also have a separate reporting framework 136. In some examples, a single combined reporting framework 136 may be used for two or more of the file systems, wherein the combined reporting framework 136 has access to each of the corresponding databases 130. To initiate a file lookup, the client device 102 can provide search inputs to a specified reporting framework 136. The reporting framework 136 queries one or more of the databases 130 in accordance with the search input and returns a search report to the client computer 102.

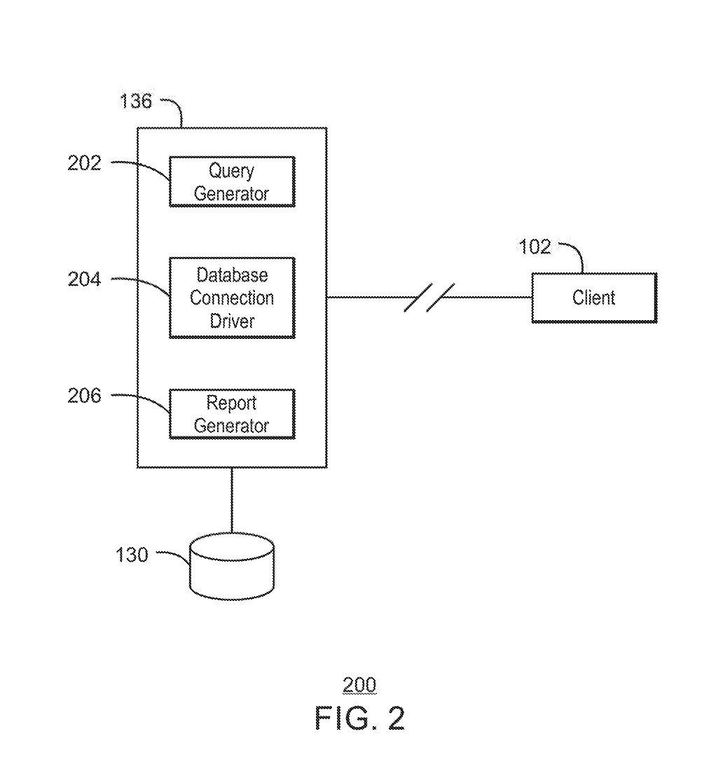

FIG. 2 is a block diagram of a system showing a more detailed example of the reporting framework of FIG. 1. The reporting framework 136 includes a combination of hardware and programming. For example, the reporting framework 136 can be a tangible, non-transitory, computer-readable medium for storing computer-readable instructions, one or more processors for executing the instructions, or a combination thereof.

The reporting framework 136 may include a query generator 202, a database connection driver 204, and report generator 206. The query generator 202 is used to generate a query based on the search criteria received from the client 102. For example, the query generator 202 may generate a Structured Query Language (SQL) query. In some examples, the query is a complex query. As used herein, the term “complex query” refers to a query that includes two or more filtering parameters joined by one or more Boolean operators.

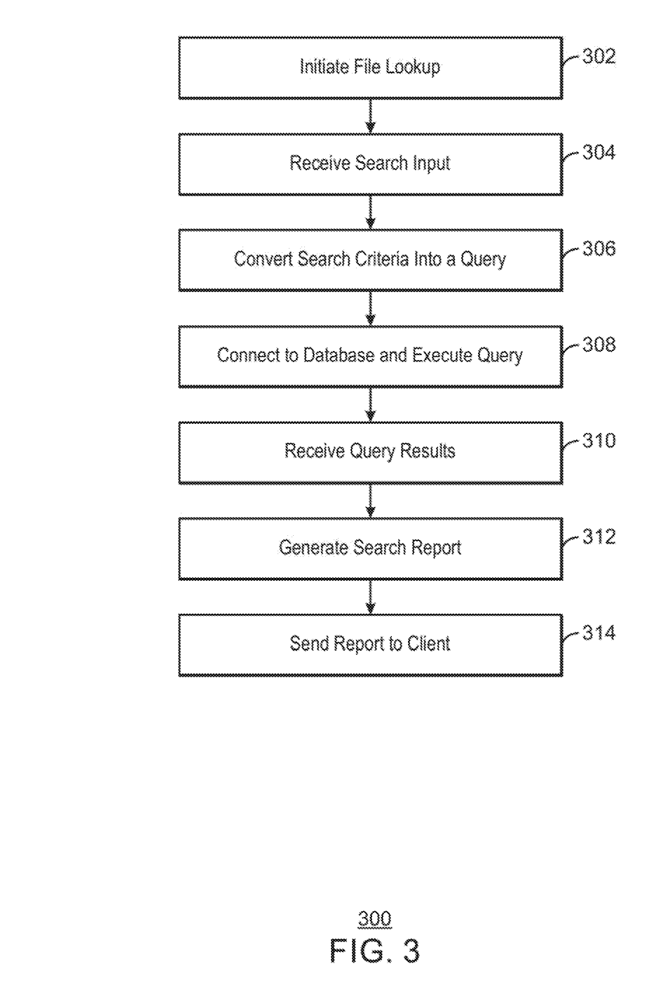

The database connection driver 204 is used to establish a connection to the appropriate file system database 130 and execute the query on the database 130. The report generator 206 generates the search report based on the search results and sends the search report to the client computer 102. In some examples, the report generator 206 can use a reporting tool such as JasperReports to convert the search results into a standard file type such as Portable Document Format (PDF), HyperText Markup Language (HTML), a Spreadsheet, Rich Text Format (RTF), ODT, Comma-separated values (CSV), or Extensible Markup Language (XML), among others. An example of a method for performing a file lookup is explained in more detail below with reference to FIG. 3.

FIG. 3 is a process flow diagram of a method of performing a file lookup. The method 300 can be performed by the reporting framework 136. The method 300 can begin at block 302, wherein a file lookup is initiated. In some examples, the file lookup can be initiated by a user at a client computer using, for examples, the file lookup utility 134 of FIG. 1. In some examples, the file lookup can be initiated automatically as a part of a scheduled data collection process.

To initiate a file lookup, the user can specify various search inputs to be used for the file lookup command. Some or all of the search inputs can be specified by a user through the file lookup utility 134. Additionally, some search inputs some search inputs may also be specified as default values that are preprogrammed into the file lookup utility or configured by an administrator, for example. The search inputs can include one or more file system names on which to execute the lookup, the search criteria used for the lookup, and other search parameters. The search inputs can be used to generate a lookup command file that can be sent to a reporting framework corresponding to the specified file system or file systems. The lookup command file includes the search inputs and can be generated by the file lookup utility. In some examples, the lookup command file is an XML file.

In some examples, the search criteria can include a single search token, such as a filename or folder name, for example. In some examples, the search criteria can include multiple search tokens, which can combined using Boolean operators such as “AND”, “OR”, and parentheses. The search inputs can also include various search parameters used to affect how the search is conducted or how the search results are presented. For example, one search parameter can indicate that the results should be sorted in ascending or descending order based on file name or file size, for example. Another search parameter can indicate whether results are shown on a display such as display 108 or sent to a printer. Another search parameter can indicate a file type for an output file to which the search results are to be exported.

At block 302, the lookup command file, including the search input, is received by the reporting framework. The lookup command file may be processed to obtain the search criteria and other search parameters. If the reporting framework is used for more than one file system, the lookup command file may also have the file system names that the user has specified.

At block 304, a query is generated based on the search criteria. As explained above, the query may be a complex query that includes two or more search tokens, Boolean operators, and parentheses. Generating the query may include obtaining the appropriate Table name to query, generating a “Where” clause from the search inputs, generating a “Group” clause from the group criteria, generating an “OrderBy” clause from the sort criteria parameter, and generating a “Select Statement” query using the table name and above clauses. In some examples, more than one file system is specified and a corresponding number of queries is generated for each of the file system databases.

At block 306, a connection to the database of the specified file system is established and the query is executed on the database. In some examples, if more than one file system is specified in the lookup command file, then a the query is executed on each of the corresponding file system databases.

At block 308, search results are received from the database. The search result may contain the rows and columns of the database that satisfy the search criteria. The search results may also be organized in accordance with the search parameters. In some examples, the rows and columns of the database that satisfy the search criteria is referred to herein as the “ResultSet Object.” The ResultSet Object can be returned form the database to the reporting framework.

At block 310, a search report is generated based on the search results. For example, the search report may generated by the report generator 206 of FIG. 2 based on the ResultSet object and various report parameters such as report name, title, and table name, among others. In some examples, the report generator may use application programming interfaces (APIs) such as Jasper library APIs to generate the report. For example, the report parameters and the ResultSet object may be sent to a pre-compiled Jasper file (.jasper) to generate a Jasper Print file (.jrprint) using the Jasper Ubrary's fillReportTOFile API. The generated Jasper Print file can be used to export the report to the specified file format, using the appropriate Jasper Reports exporter API.

At block 312, the reporting framework then sends the generated report back to the client computer 102 that initiated the file lookup. Upon receipt of the report, the client computer 102 may automatically save the report, send the report to a display 108, or print the report, for example. The report can list one or more files that match the search input provided by the user. In some examples, additional information about each file may be obtained from the database and used in the report, such as file size, and any other metadata associated with the file, including custom metadata.

In some example, the file lookup can be performed on multiple file systems. For example, the client machine can send the two or more search command files to two or more file systems, each of which have their own database and search module. In some examples, reports may be generated automatically. For example, reports can be generated according to a specified schedule.

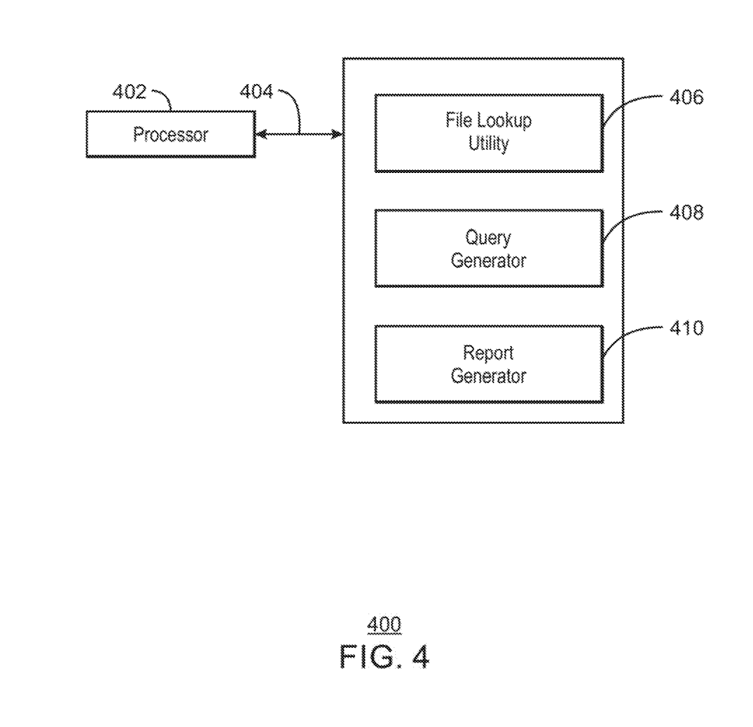

FIG. 4 is a block diagram showing a tangible, non-transitory, computer-readable medium that stores code configured to perform a file lookup. The computer-readable medium is referred to by the reference number 400. The computer-readable medium 400 can include RAM, a hard disk drive, an array of hard disk drives, an optical drive, an array of optical drives, a non-volatile memory, a flash drive, a digital versatile disk (DVD), or a compact disk (CD), among others. The computer-readable medium 400 may be accessed by a processor 402 over a computer bus 404. Furthermore, the computer-readable medium 400 may include computer code and data configured to perform the methods described herein.

The various software components discussed above may be stored on the tangible, non-transitory, computer-readable medium 400. For example, a region 406 on the computer-readable medium 400 can include a file lookup utility that enables a user to specify search input for a file lookup. A region 408 can include a query generator that generates a complex query based on the search input. A region 410 can include a report generator that generates a report based on the search results returned by the database. Although shown as contiguous blocks, the software components can be stored in any order or configuration. For example, if the tangible, non-transitory, computer-readable medium is a hard drive, the software components can be stored in non-contiguous, or even overlapping, sectors.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A system, comprising:
a file system corresponding to one or more physical storage devices;
a database that stores metadata corresponding to files in the file system; and
a reporting framework that receives search criteria for a file lookup, generates a complex query based on the search criteria, sends the complex query to the database, receives search results corresponding to the complex query, and generates a search report based on the search results;
wherein the search criteria include two or more search tokens and one or more Boolean operators.

2. The system of claim 1, wherein the metadata stored to the database comprises custom metadata.

3. The system of claim 1, wherein the database is a pipelined database.

4. The system of claim 1, wherein the file system represents data stored to a cloud computing system and the physical storage devices are components of the cloud computing system.

5. The system of claim 1, wherein the file system represents data stored to an enterprise network and the physical storage devices are storage arrays within the enterprise network.

6. The system of claim 1, comprising:
a second file system;
a second database that stores metadata corresponding to files in the second file system;
wherein the search criteria are provided by a client computer to the first file system and the second file system to perform the file lookup on both the first file system and the second file system at substantially the same time.

7. The system of claim 6, comprising a second reporting framework that receives the search criteria for the file lookup, generates a second complex query based on the search criteria, sends the second complex query to the second database, receives second search results corresponding to the second complex query, and generates a second search report based on the second search results.

8. A method, comprising:
receiving search criteria for a file lookup to be performed for files in a file system, wherein the search criteria include two or more search tokens and one or more Boolean operators;
generating a complex query based on the search criteria;
sending the complex query to a database that stores metadata corresponding to the files in the file system;
receiving search results from the database corresponding to the complex query; and
generating a search report based on the search results.

9. The method of claim 8, wherein the search criteria include a filter parameter corresponding to a custom metadata tag of the files in the file system.

10. The method of claim 8, comprising:
generating a lookup command file that includes the search criteria; and
initiating the file lookup by sending the lookup command file to a reporting framework associated with the file system and coupled to the database.

11. The method of claim 8, generating the search report comprises exporting the search results to a document with a file type specified in the search criteria.

12. The method of claim 8, comprising:
generating a database record in response to an event produced by updating the file in the file system, wherein the database record comprises updated file metadata for the file; and
adding the database record to the database.

13. A tangible, non-transitory, computer-readable medium comprising instructions that direct a processor to:
receive search criteria for a file lookup to be performed for files in a file system, wherein the search criteria include two or more search tokens and one or more Boolean operators;
generate a complex query based on the search criteria;
send the complex query to a database that stores metadata corresponding to the files in the file system;
receive search results from the database corresponding to the complex query; and
generate a search report based on the search results.

14. The computer-readable medium of claim 13, wherein the search criteria include a filter parameter corresponding to a custom metadata tag of the files in the file system.

15. The computer-readable medium of claim 13, comprising instructions that direct the processor to:
send the complex query to a second database corresponding to files in a second file system;
receive search results from the second database; and
include the search results from the second database in the search report.
